(19) United States
(12) Patent Application Publication
(10) Pub. No.: US 2016/0063871 A1
(43) Pub. Date: Mar. 3, 2016

(54) ONLINE LEARNING STYLE AUTOMATED DIAGNOSTIC SYSTEM, ONLINE LEARNING STYLE AUTOMATED DIAGNOSTIC METHOD AND NON-TRANSITORY COMPUTER READABLE RECORDING MEDIUM

(71) Applicant: INSTITUTE FOR INFORMATION INDUSTRY, Taipei (TW)

(72) Inventors: Hsiao-Chien TSENG, Yilan County (TW); Shih-Hsin HU, Kaohsiung City (TW)

(21) Appl. No.: 14/520,326

(22) Filed: Oct. 21, 2014

(30) Foreign Application Priority Data
Sep. 2, 2014 (TW) 103130285

(51) Int. Cl. G09B 5/00; G06Q 50/20

(52) U.S. Cl. CPC G09B 5/00; G06Q 50/20

(57) ABSTRACT

The present invention provides an online learning style automated diagnostic system and method, and a computer readable recording medium; the online learning style automated diagnostic method includes following steps. A plurality of messages sent by learning platforms are received through a network communication device and are stored in a learning database, in which each message includes relevant data corresponding to a learner's learning behavior. It is determined that the learning behavior belongs to at least one learn style. Outliers of the correlation data are found, and then the outliers are filtered out from the correlation data to generate a set of data, in which a maximum value of the set of data is calculated. Each of the set of data is divided by the maximum value to give a conversion value, and a score of the learner in the learning style is calculated based on the conversion value.

### RELATED APPLICATION LICATIONS

This application claims priority to Taiwan Application Serial Number 103130285, filed Sep. 2, 2014, which is herein incorporated by reference.

### BACKGROUND

1. Field of Invention

The present invention relates to a learning style diagnostic method. More particularly, the present invention relates to an algorithm for real-time detection of a learning behavior online.

2. Description of Related Art

Learning is a process in which knowledge, skills, attitudes, or values are acquired through teaching or experiencing, which leads to a stable behavioral change that is measurable; more precisely, this process can be used to establish a new mental infrastructure or to review a past mental infrastructure.

Most conventional learning style diagnostic methods provide paper-based questionnaire for diagnosis purpose. However, the paper-based questionnaire cannot detect the learner's learning style in real-time.

In view of the foregoing, regarding the conventional paper-based questionnaire, there exist problems and disadvantages in the related art for further improvement; however, those skilled in the art sought vainly for a suitable solution. In order to solve or circumvent above problems and disadvantages, there is an urgent need in the related field to provide means for analyzing a learner's learning style instantly.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides an online learning style automated diagnostic system, an online learning style automated diagnostic method, and a non-transitory computer-readable recording medium to solve or circumvent aforesaid problems and disadvantages.

According to embodiments of the present disclosure, the online learning style automated diagnostic system comprises a learning database, a processor, a network communication device, and a memory. The processor is configured to execute one or more computer-executable instructions, the memory comprises a computer program that is executable by the processor, and when the computer program is executed by the processor, the processor is configured to perform the following actions of: receiving a plurality of messages respectively sent from a plurality of learning platforms via the network communication device, and storing the plurality of messages to the learning database, wherein each of the plurality of messages records relevant data corresponding to a learner's at least one learning behavior; determining a learning style to which the at least one learning behavior belongs; screening outliers of the plurality of relevant data; filtering out the outliers from the plurality of relevant data to obtain a set of data and calculating a maximum value of the set of data; calculating a conversion value for each of the set of data, wherein the conversion value equals to dividing each of the set of data by the maximum value; and calculating a score of the learner in the learning style based on the conversion value.

In one embodiment, the processor is further configured to perform the following actions of: calculating a mean of the relevant data of the plurality of learning behavior; calculating a standard deviation of the relevant data of the plurality of learning behavior; adding the mean with a pre-determined fold of the standard deviation to obtain an upper-limit value, and subtracting the pre-determined fold of the standard deviation from the mean to obtain a lower-limit value; and selecting, from the relevant data of the plurality of learning behavior, the relevant data greater than the upper-limit value or less than the lower-limit value as the outliers.

In one embodiment, the pre-determined fold is 3-fold.

In one embodiment, the conversion value is substituted in score model to obtain the score.

In one embodiment, the score model satisfies the following equation:

$$Score ( Type ) = \frac{{\sum }_{i = 1}^{{N}_{type}} ⌈ {( \frac{{Type}_{i}}{max f ( {Type}_{i} )} )}^{{u}_{i}} \times {( 1 - \frac{{Type}_{i}}{max f ( {Type}_{i} )} )}^{1 - {u}_{i }} ⌉ \times 100}{{N}_{type}} ,$$

wherein Typeᵢ is the relevant data corresponding to a learner's at least one learning behavior in the learning style, max f(Typeᵢ) is the maximum value, N_{type} is a number of the at least one learning behavior in the learning style, Score (Type) is the score; and if the at least one learning behavior in the learning style is positive, uᵢ is 1; or if the at least one learning behavior in the learning style is negative, uᵢ is 0.

In one embodiment, the messages received by the network communication device are in a hypertext transfer protocol (HTTP) format.

In another aspect, the online learning style automated diagnostic method according to embodiments of the present disclosure comprises the steps of: (a) receiving a plurality of messages respectively sent from a plurality of learning platforms via a network communication device, and storing the plurality of messages to a learning database, wherein each of the plurality of messages records relevant data corresponding to a learner's at least one learning behavior; (b) determining a learning style to which the at least one learning behavior belongs; (c) screening outliers of the plurality of relevant data; (d) filtering out the outliers from the plurality of relevant data to obtain a set of data and calculating a maximum value of the set of data; (e) calculating a conversion value for each of the set of data, wherein the conversion value equals to dividing each of the set of data by the maximum value; and (f) calculating a score of the learner in the learning style based on the conversion value.

In one embodiment, the step (c) comprises: calculating a mean of the relevant data of the plurality of learning behavior; calculating a standard deviation of the relevant data of the plurality of learning behavior; adding the mean with a pre-determined fold of the standard deviation to obtain an upper-limit value, and subtracting the pre-determined fold of the standard deviation from the mean to obtain a lower-limit value; and selecting, from the relevant data of the plurality of learning behavior, the relevant data greater than the upper-limit value or less than the lower-limit value as the outliers.

In one embodiment, the pre-determined fold is 3-fold.

In one embodiment, the conversion value is substituted in score model to obtain the score.

In one embodiment, the score model satisfies the following equation:

$$Score ( Type ) = \frac{{\sum }_{i = 1}^{{N}_{type}} ⌈ {( \frac{{Type}_{i}}{max f ( {Type}_{i} )} )}^{{u}_{i}} \times {( 1 - \frac{{Type}_{i}}{max f ( {Type}_{i} )} )}^{1 - {u}_{i }} ⌉ \times 100}{{N}_{type}} ,$$

wherein Typeᵢ is the relevant data corresponding to a learner's at least one learning behavior in the learning style, max f(Typeᵢ) is the maximum value, N_{type} is a number of the at least one learning behavior in the learning style, Score(Type) is the score; and if the at least one learning behavior in the learning style is positive, uᵢ is 1; or if the at least one learning behavior in the learning style is negative, uᵢ is 0.

In one embodiment, the messages received by the network communication device are in a hypertext transfer protocol (HTTP) format.

In yet another aspect, the non-transitory computer-readable recording medium according to embodiments of the present disclosure has at least one computer program, the at least one computer program has a plurality of instructions, and when the plurality of instructions are executed by a computer, the computer is instructed to execute the above-mentioned automated diagnostic learning style method.

In view of the foregoing, the present invention performs real-time learning style diagnosis based on the online learning behavior of a learner to replace the conventional paper-based questionnaire.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of an online learning style automated diagnostic system according to one embodiment of the present disclosure; and

FIG. 2 is a flow chart illustrating an online learning style automated diagnostic method according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

In the detailed embodiment and the claims, unless otherwise indicated, the article “a” or “the” refers to one or more than one of the word modified by the article “a” or “the.”

Through the present specification and the annexed claims, the description involving the “electrical connection” refers to the cases where one component is electrically connected to another component indirectly via other component(s), or one component is electrically connected to another component directly without any other component.

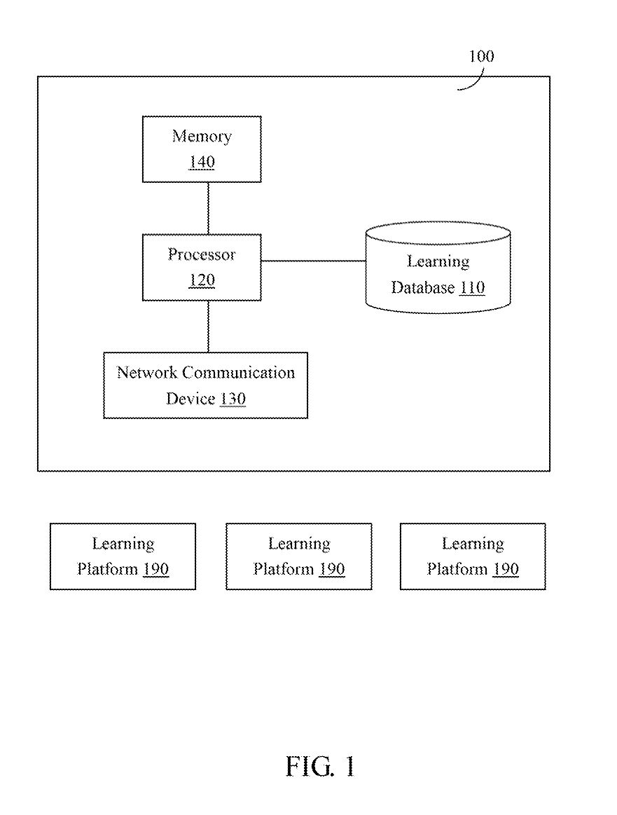

FIG. 1 is a block diagram of an online learning style automated diagnostic system 100 according to one embodiment of the present disclosure. As illustrated in FIG. 1, the online learning style automated diagnostic system 100 comprises a learning database 110, a processor 120, a network communication device 130, and a memory 140. In structure, the learning database 110, the network communication device 130, and the memory 140 are electrically connected to the processor 120; and the network communication device 130 and the learning platforms 190 are communicated via a network. For example, the learning platforms 190 can be a tablet computer, smart phone, notebook, desktop computer, etc., the network communication device 130 can be an Ethernet card or a wireless network card, the processor 120 can be a central processor, microcontroller or the like, the memory 140 can be an integrated circuit of any type which is adapted to store digital data or any other storage component (such as, ROM, RAM, etc.), the learning database 110 can be stored in different storage devices or in a single storage device, such as a computer hard drive, server, or any other recording medium.

During operation, users can operate via various learning platforms 190, in which the users' learning behavior in the learning platforms 190 is sent to the online learning style automated diagnostic system 100 via messages in the hypertext transfer protocol (HTTP) format, so as to collect the cross-platform learning behaviors.

In the online learning style automated diagnostic system 100, the processor 120 can execute one or more computer-executable instructions, and the memory 140 comprises a computer program which can be executed by the processor, so that when the computer program is executed by the processor 120, the computer program causes the processor 120 to carry out the online learning style automated diagnostic method; specifically, the processor 120 receives a plurality of messages respectively sent from a plurality of learning platforms 190 via the network communication device 130 to collect the cross-platform learning behaviors; and stores the plurality of messages to the learning database 110 to provide subsequent learning behavior records, wherein each of the plurality of messages records relevant data corresponding to a learner's at least one learning behavior.

Regarding the learning behavior records, the processor 120 may retrieve and analyze the required information from the learning database 110, and then a learning behavior recoding module is used to resolve the learning behavior, thereby resolving the learning records into five aspects including, who, what, when, where, and which.

On the other hand, regarding the learning style diagnosis, the processor 120 determines a learning style to which the at least one learning behavior belongs; that is, determines the respective learning style that various learning behaviors belong to. Next, the processor 120 screens the outliers in the plurality of relevant data, so that the outliers would not jeopardize the overall subsequent analysis. Thereafter, the processor 120 calculates a maximum value in a set of data in which the outliers in the plurality of relevant data are excluded; it should be noted that this step should be carried out after the outliers are filtered out, so as to prevent the occurrence of over-estimation. Thereafter, the processor 120 calculates a conversion value for each datum of the set of data in which each datum is divided by the maximum value, so as to prevent the problem arisen from the different metrics. Subsequently, the processor 120 calculates a score of the learner in the learning style based on the conversion value. In this way, the online learning style automated diagnostic system 100 uses the learner's online learning behavior as the basis for real-time learning style diagnosis, as opposed to the conventional determination based on questionnaires.

Regarding specific means for identifying outliers, in one embodiment, the processor 120 is configured to perform the following actions: calculating a mean of the relevant data of the plurality of learning behavior; calculating a standard deviation of the relevant data of the plurality of learning behavior; adding the mean with a pre-determined fold of the standard deviation to obtain an upper-limit value, and subtracting the pre-determined fold of the standard deviation from the mean to obtain a lower-limit value; and selecting, from the relevant data of the plurality of learning behavior, the relevant data greater than the upper-limit value or less than the lower-limit value as the outliers. Further, in one preferred embodiment, the pre-determined fold is 3-fold; in practice, if the pre-determined fold is greater than 3-fold, over-estimation may occur; while in contrast, if the pre-determined fold is less than 3-fold, the confidence interval may be too small, which may affect the subsequent analysis.

In one embodiment, the above-mentioned learning style comprises eight types: active, reflective, sensing, intuitive, visual, verbal, sequential, and global. Specifically, the active-type learners would like to experience things personally, and collaborate with others in an active learning way; they would methodologically discuss, explain, or test a new piece of information. The reflective-type learners are used to think thoroughly and tend to work alone during the learning process; they would deliberate, investigate, or utilize the new information. The sensing-type learners perceive through the sensual way, and collect data through perception (e.g., observation). The sensing-type learners love things that are concrete and related to the daily life, and once they realize the connection between the knowledge being taught and the real life, they can memorize and understands the knowledge more effectively. The intuitive-type learners discover and observe the possibility while they are not particularly aware of this process; they tend to feel indirectly, such as by speculation, pre-perception, and imagination. The most appropriate memorizing means for the visual-type learners would be drawings, charts, line graphs, and actual demonstrations. The verbal-type learners prefer to learn by writing or oral recitation. The sequential-type learners solve the problem using linear thinking; they are good at convergent thinking and analyzing; they are more effective in learning after fully understanding the materials provided during the learning process, in a well-prepared condition and in complicated and difficult cases. The global-type learners solve the problems by jump thinking; they are good at divergent thinking, and have a vision of a wider creativity.

The score of a learner each learning style is further discussed below, in one embodiment, the above-mentioned conversion value is substituted in a score model to obtain the score, the score model satisfies the following equation:

$$Score ( Type ) = \frac{{\sum }_{i = 1}^{{N}_{type}} ⌈ {( \frac{{Type}_{i}}{max f ( {Type}_{i} )} )}^{{u}_{i}} \times {( 1 - \frac{{Type}_{i}}{max f ( {Type}_{i} )} )}^{1 - {u}_{i }} ⌉ \times 100}{{N}_{type}} ,$$

wherein Typeᵢ is the relevant data corresponding to a learner's at least one learning behavior in the learning style, max f(Typeᵢ) is the maximum value, N_{type} is a number of the at least one learning behavior in the learning style, Score(Type) is the score; and if the at least one learning behavior in the learning style is positive, uᵢ is 1; or if the at least one learning behavior in the learning style is negative, uᵢ is 0.

For example, please refer to the actual examples provided in the table below:

| | 1 point | | | | | | |
|---|---|---|---|---|---|---|---|
| | for positive | | | | | | |
| | 0 point | | | | | | |
| | for negative | | Raw relevant data | | | Conversion value | |
| | Ac- | Reflec- | Student | Student | | Student | Student |
| | tive | tive | A | B | Max | A | B |
| Answering | 1 | 0 | 8 | 1 | 10 | 0.8 | 0.1 |
| Asking | 1 | 0 | 7 | 0 | 10 | 0.7 | 0 |
| Time for | | 1 | 120 | 180 | 200 | 0.6 | 0.9 |
| testing | | | | | | | |
| Viewing | | 1 | 200 | 480 | 500 | 0.4 | 0.96 |
| video | | | | | | | |

Substituting the data in the table above into the score model, Student A in the active learning style has a score of [0.8+0.7]×100/2=75, and in the introspective learning style, the score is [(1−0.8)+(1−0.7)+0.6+0.4]×100/4=37.5; Student B in the active learning style has a score of [0.1+0]×100/2=5, and in the introspective learning style, the score is [(1−0.1)+(1−0)+0.9+0.96]×100/4=94. In this way, the online learning style automated diagnostic system 100 may diagnose the learning style of a student, and reflect the learning condition of the learner, in which the diagnosis is accurate and effective.

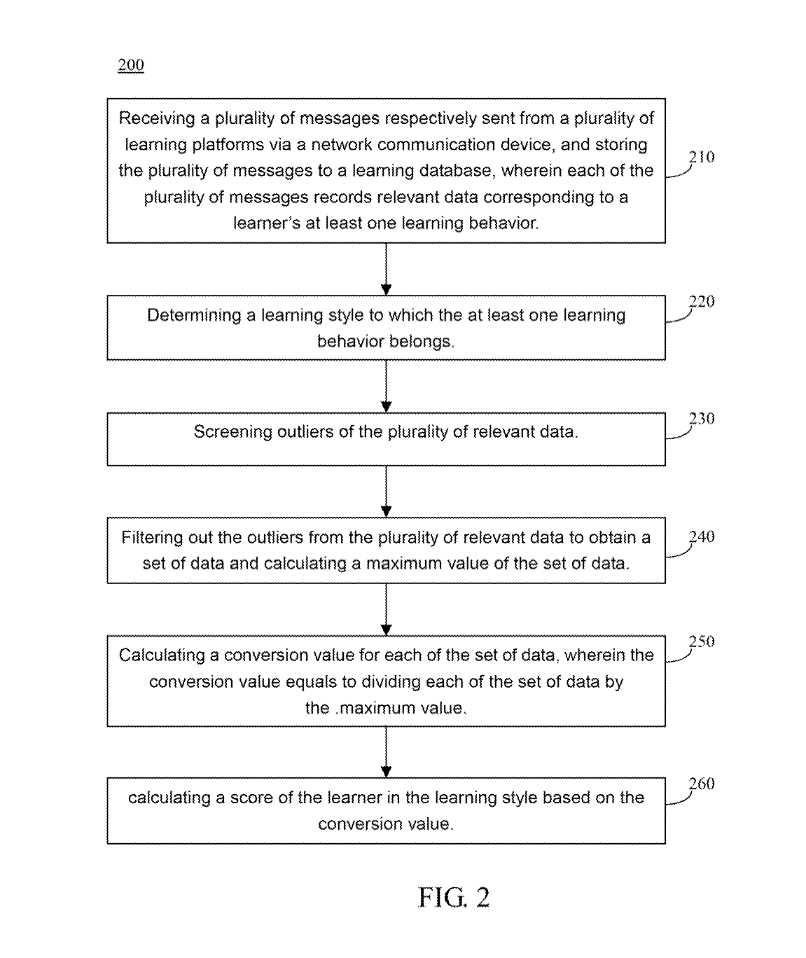

FIG. 2 is a flow chart illustrating an online learning style automated diagnostic method 200 according to one embodiment of the present disclosure. The online learning style automated diagnostic method 200 can be implemented by a computer, such as the above-mentioned online learning style automated diagnostic system 100; alternatively, a portion of the function of the online learning style automated diagnostic method 200 can be implemented as at least one computer program, and stored in a non-transitory computer-readable recording medium; the at least one computer program has a plurality of instructions, which when executed in a computer causes the computer to execute the online learning style automated diagnostic method 200.

As illustrated in FIG. 2, the online learning style automated diagnostic method 200 comprises the steps 210-260. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently. As to the hardware devices required for the implementation of these steps, they have been specifically disclosed in the above-mentioned embodiments, and hence will not be repeated hereinbelow.

Regarding the cross-platform collection of the learning behavior, in step 210, a plurality of messages respectively sent from a plurality of learning platforms are received via a network communication device, and the plurality of messages are stored to a learning database, in which each of the plurality of messages records relevant data corresponding to a learner's at least one learning behavior. Further, regarding the learning behavior record, in step 210, the required information is retrieved from a learning database and analyzed, and then a learning behavior recoding module is used to resolve the learning behavior into aspects including who (subject), what (object), when (time), where (location), why (reason) and how (working).

On the other hand, regarding the learning style diagnosis, in step 220, a learning style to which the at least one learning behavior belongs is determined; next, in step 230, the outliers in the plurality of relevant data are screened, then, in step 240 a maximum value in a set of data is calculated wherein the outliers in the plurality of relevant data are excluded to obtain the set of data; thereafter, in step 250, a conversion value for each datum of the set of data is calculated wherein each datum is divided by the maximum value; then in step 260, a score of the learner in the learning style is calculated based on the conversion value. In this way, the online learning style automated diagnostic method 200 uses the learner's online learning behavior as the basis for real-time learning style diagnosis, as opposed to the conventional determination based on questionnaires.

In one embodiment, the step 230 comprises: calculating a mean of the relevant data of the plurality of learning behavior; calculating a standard deviation of the relevant data of the plurality of learning behavior; adding the mean with a pre-determined fold of the standard deviation to obtain an upper-limit value, and subtracting the pre-determined fold of the standard deviation from the mean to obtain a lower-limit value; and selecting, from the relevant data of the plurality of learning behavior, the relevant data greater than the upper-limit value or less than the lower-limit value as the outliers. Further, in one preferred embodiment, the pre-determined fold is 3-fold; in practice, if the pre-determined fold is greater than 3-fold, over-estimation may occur; while in contrast, if the pre-determined fold is less than 3-fold, the confidence interval may be too small, which may affect the subsequent analysis.

In one embodiment, in step 260, the conversion value is substituted in a score model to obtain the score; the equation of the score model has been disclosed in the above embodiments, and hence, will not be repeated here for the sake of brevity.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. An online learning style automated diagnostic system, comprising:
a learning database;
a processor, configured to execute one or more computer-executable instructions;
a network communication device; and
a memory, comprising a computer program executable by the processor, wherein when the computer program is executed by the processor, the processor is configured to perform operations comprising:
receiving a plurality of messages respectively sent from a plurality of learning platforms via the network communication device, and storing the plurality of messages to the learning database, wherein each of the plurality of messages records relevant data corresponding to a learner's at least one learning behavior;
determining a learning style to which the at least one learning behavior belongs;
screening outliers of the plurality of relevant data;
filtering out the outliers from the plurality of relevant data to obtain a set of data and calculating a maximum value of the set of data;
calculating a conversion value for each of the set of data, wherein the conversion value equals to dividing each of the set of data by the maximum value; and
calculating a score of the learner in the learning style based on the conversion value.

2. The learning style system of claim 1, wherein the processor is further configured to perform operations comprising:
calculating a mean of the relevant data of the plurality of learning behavior;
calculating a standard deviation of the relevant data of the plurality of learning behavior,
adding the mean with a pre-determined fold of the standard deviation to obtain an upper-limit value, and subtracting the pre-determined fold of the standard deviation from the mean to obtain a lower-limit value; and
selecting, from the relevant data of the plurality of learning behavior, the relevant data greater than the upper-limit value or less than the lower-limit value as the outliers.

3. The learning style system of claim 2, wherein the pre-determined fold is 3-fold.

4. The learning style system of claim 1, wherein the conversion value is substituted in a score model to obtain the score.

5. The learning style system of claim 4, wherein the score model satisfies a following equation:
$$Score ( Type ) = \frac{{\sum }_{i = 1}^{{N}_{type}} ⌈ {( \frac{{Type}_{i}}{max f ( {Type}_{i} )} )}^{{u}_{i}} \times {( 1 - \frac{{Type}_{i}}{max f ( {Type}_{i} )} )}^{1 - {u}_{i }} ⌉ \times 100}{{N}_{type}}$$
wherein Typeᵢ is the relevant data corresponding to a learner's at least one learning behavior in the learning style, max f(Typeᵢ) is the maximum value, N_{type} is a number of the at least one learning behavior in the learning style, Score(Type) is the score; and if the at least one learning behavior in the learning style is positive, uᵢ is 1; or if the at least one learning behavior in the learning style is negative, uᵢ is 0.

6. The learning style system of claim 1, wherein the messages received by the network communication device are in a hypertext transfer protocol (HTTP) format.

7. An online learning style automated diagnostic method, comprising steps of,
(a) receiving a plurality of messages respectively sent from a plurality of learning platforms via a network communication device, and storing the plurality of messages to a learning database, wherein each of the plurality of messages records relevant data corresponding to a learner's at least one learning behavior;
(b) determining a learning style to which the at least one learning behavior belongs;
(c) screening outliers of the plurality of relevant data;
(d) filtering out the outliers from the plurality of relevant data to obtain a set of data and calculating a maximum value of the set of data;
(e) calculating a conversion value for each of the set of data, wherein the conversion value equals to dividing each of the set of data by the maximum value; and
(f) calculating a score of the learner in the learning style based on the conversion value.

8. The online learning style automated diagnostic method of claim 7, wherein the step (c) comprises,
calculating a mean of the relevant data of the plurality of learning behavior;
calculating a standard deviation of the relevant data of the plurality of learning behavior;
adding the mean with a pre-determined fold of the standard deviation to obtain an upper-limit value, and subtracting the pre-determined fold of the standard deviation from the mean to obtain a lower-limit value; and
selecting, from the relevant data of the plurality of learning behavior, the relevant data greater than the upper-limit value or less than the lower-limit value as the outliers.

9. The online learning style automated diagnostic method of claim 8, wherein the pre-determined fold is 3-fold.

10. The online learning style automated diagnostic method of claim 7, wherein the conversion value is substituted in a score model to obtain the score.

11. The online learning style automated diagnostic method of claim 10, wherein the score model satisfies a following equation:
$$Score ( Type ) = \frac{{\sum }_{i = 1}^{{N}_{type}} ⌈ {( \frac{{Type}_{i}}{max f ( {Type}_{i} )} )}^{{u}_{i}} \times {( 1 - \frac{{Type}_{i}}{max f ( {Type}_{i} )} )}^{1 - {u}_{i }} ⌉ \times 100}{{N}_{type}}$$
wherein Typeᵢ is the relevant data corresponding to a learner's at least one learning behavior in the learning style, max f(Typeᵢ) is the maximum value, N_{type} is a number of the at least one learning behavior in the learning style, Score(Type) is the score; and if the at least one learning behavior in the learning style is positive, uᵢ is 1; or if the at least one learning behavior in the learning style is negative, uᵢ is 0.

12. The online learning style automated diagnostic method of claim 7, wherein the messages received by the network communication device are in a hypertext transfer protocol (HTTP) format.

13. A non-transitory computer-readable recording medium having at least one computer program stored therein, the at least one computer program having a plurality of instructions, wherein the plurality of instructions, while being executed by a computer, is configured to instruct the computer to execute steps of,
(a) receiving a plurality of messages respectively sent from a plurality of learning platforms via a network communication device, and storing the plurality of messages to a learning database, wherein each of the plurality of messages records relevant data corresponding to a learner's at least one learning behavior;
(b) determining a learning style to which the at least one learning behavior belongs;
(c) screening outliers of the plurality of relevant data;
(d) filtering out the outliers from the plurality of relevant data to obtain a set of data and calculating a maximum value of the set of data;
(e) calculating a conversion value for each of the set of data, wherein the conversion value equals to dividing each of the set of data by the maximum value; and
(f) calculating a score of the learner in the learning style based on the conversion value.

14. The non-transitory computer-readable recording medium of claim 13, wherein the step (c) comprises:
calculating a mean of the relevant data of the plurality of learning behavior;
calculating a standard deviation of the relevant data of the plurality of learning behavior,
adding the mean with a pre-determined fold of the standard deviation to obtain an upper-limit value, and subtracting the pre-determined fold of the standard deviation from the mean to obtain a lower-limit value; and
selecting, from the relevant data of the plurality of learning behavior, the relevant data greater than the upper-limit value or less than the lower-limit value as the outliers.

15. The non-transitory computer-readable recording medium of claim 14, wherein the pre-determined fold is 3-fold.

16. The non-transitory computer-readable recording medium of claim 13, wherein the conversion value is substituted in a score model to obtain the score.

17. The non-transitory computer-readable recording medium of claim 16, wherein the score model satisfies a following equation:
$$Score ( Type ) = \frac{{\sum }_{i = 1}^{{N}_{type}} ⌈ {( \frac{{Type}_{i}}{max f ( {Type}_{i} )} )}^{{u}_{i}} \times {( 1 - \frac{{Type}_{i}}{max f ( {Type}_{i} )} )}^{1 - {u}_{i }} ⌉ \times 100}{{N}_{type}}$$
wherein Typeᵢ is the relevant data corresponding to a learner's at least one learning behavior in the learning style, max f(Typeᵢ) is the maximum value, N_{type} is a number of the at least one learning behavior in the learning style, Score(Type) is the score; and if the at least one learning behavior in the learning style is positive, uᵢ is 1; or if the at least one learning behavior in the learning style is negative, uᵢ is 0.

18. The non-transitory computer-readable recording medium of claim 13, wherein the messages received by the network communication device are in a hypertext transfer protocol (HTTP) format.
